(19) United States
(12) Patent Application Publication
(10) Pub. No.: US 2012/0261946 A1
(43) Pub. Date: Oct. 18, 2012

(54) AERODYNAMIC VEHICLE AID

(76) Inventor: Kenneth Steel, Kenmure (NZ)

(21) Appl. No.: 12/935,700

(22) PCT Filed: Mar. 30, 2009
(86) PCT No.: PCT/NZ09/00044

§ 371 Date: Jan. 28, 2011

(30) Foreign Application Priority Data
Mar. 30, 2008 (NZ) 565720
Aug. 11, 2008 (NZ) 570411

(51) Int. Cl. B62D 37/02; B62D 35/00

(52) U.S. Cl. 296/180.5; 296/181.5

(57) ABSTRACT

A leading edge aerodynamic aid for a vehicle or part thereof, the aid being locatable at an uppermost leading edge of the vehicle and including; a first aerofoil portion extending substantially transversely to an airflow generated by forward movement of the vehicle, the first aerofoil having an arcuate portion projecting forward of the vehicle body with upper and lower regions extending from the arcuate portion toward the vehicle body; and a second aerofoil, oriented substantially transversely to said airflow and substantially parallel to, vertically adjacent and trailing said arcuate portion of the first aerofoil, configured such that said airflow interacts with the aerodynamic aid and at least a portion of said airflow is diverted between the first and second aerofoils; and wherein the first aerofoil substantially spans the width of the vehicle to which it is attached.

### STATEMENT OF CORRESPONDING APPLICATIONS

This application is based on the Provisional Specification filed in relation to New Zealand Patent Application Numbers 565720 and 570411, the entire contents of which are incorporated herein by reference

### TECHNICAL FIELD

The present invention relates to an aerodynamic vehicle aid. In particular the present invention is concerned with devices for enhancing the aerodynamics of vehicles.

### BACKGROUND ART

The present invention has particular application to cargo haulage vehicles such as trucks and trains. However, it should be appreciated that the present invention also has application to other vehicle types.

For ease of reference only the present invention will now be described in relation to trucks.

The need to optimise cargo space on road haulage vehicles has created the widespread adoption of cuboid ‘box-like’ truck storage compartments. The inherently high drag aerodynamics of such shapes has given rise to countermeasures to reduce the attendant fuel consumption expended in moving such shapes.

Four types of drag reduction are germane to the present invention, namely Frontal drag, Leeside drag, Rear Panel drag and, in the case of stock trucks, Side Wall drag.

Frontal drag represents the component of the total drag stemming from the gross frontal area of the body and the corresponding drag peak generated directly above the leading edge of the body.
Lee side drag denotes the drag component from airflow over the body at angle to the longitudinal axis of the vehicle. The resultant vectored or ‘effective’ off-axis airflow direction causes an effect known as ‘lee-side drag’, whereby airflow spills across the vehicle body and through any gaps between the truck and trailers, between trailers and the like, causing a turbulent low pressure region on the lee (i.e. leeward) side of the vehicle. Airflow also laterally traverses the over vehicle and (where a separation with the ground exists) under the vehicle body.
Rear Panel drag denotes the drag generated immediately aft of the rear-most panel of the vehicle caused by the turbulence of the airflow adjacent the side and roof panels of the vehicle mixing with the already turbulent airflow exiting from under the vehicle.
Side wall drag denotes the effect caused by the shearing of the airflow adjacent the vertical sidewalls of the bluff body, whereby the airflow immediately adjacent the sidewall adheres to the sidewall and is effectively stationary with respect to the vehicle. As the lateral separation from the sidewall increases, the airflow velocity increases to a peak, before reducing again to zero at a finite distance from the sidewall.

It is well known that the box-like shape of truck storage areas, and the trailer sections of a tractor-trailer combination, results from the need or desire to optimize cargo space. It is also well known that this boxlike configuration is not aerodynamically efficient and that the aerodynamic drag resulting from the box shape accounts for a considerable percentage of the fuel consumption of large trucks and tractor-trailer combinations during higher speed applications, such as on a highway. In an effort to improve the operating efficiency of such vehicles, the tops of the cabs of trucks and tractors and the upper forward ends of trailers have been provided with a wide variety of wind-foil or other wind fairing devices.

Known aerodynamic aids, including deflectors mounted atop the tractor unit, aerofoil wing-sections mounted at the trailing edge of the truck bluff body and pyramidal extensions protruding from the truck rear. However, such measures are limited in effectiveness and may breech typical regulatory provisions concerning maximum height and width for truck trailers, given their need to protrude from the existing bluff-shaped cuboid containers into the air stream. NZ Patent number 520769 typifies aerodynamic aids (specifically a leading edge aerofoil mounted on the front of the first trailer, an intermediate aerofoil mounted on the rear of the first trailer and a trailing edge aerofoil mounted on the upper rearward edge of the rear trailer) which each protrude vertically beyond the existing periphery of a standard truck trailer.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

As used herein, terms denoting orientation such as “forward”, “upper”, “lower”, “leading edge”, “trailing”, and the like are defined with respect to the present invention in use, fitted to a moving vehicle. Whilst other resultant airflows are naturally possible from movement of the vehicle in lateral, reverse, or other directions, for clarity and ease of understanding, the specification will refer to airflow generated solely by forward movement of the vehicle unless specifically described otherwise.

The present invention is primarily concerned with reducing aerodynamic drag on moving vehicles.

As used herein the term “vehicle or part thereof” refers to most forms of ground conveyance or parts thereof, having and/or conveying:
a width of substantially 1 meter or greater; and
a substantially box-like construction;
   the conveyance may usually be wheeled and may or may not have a motor. Thus, the term vehicle may include cars, boats, trucks, locomotives, trailers, carriages and the like. A part of a vehicle may include a container or other structure for housing humans, animals, substances, or objects, the container or other structure may be integral with, connected to, or supported by, a vehicle. For example, as used herein a shipping container capable of being carried by a truck or trailer is considered to be a part of a vehicle.

According to one aspect of the present invention there is provided a leading edge aerodynamic aid for a vehicle or part thereof, said aid being locatable at an uppermost leading edge of said vehicle or part thereof and including;
a first aerofoil extending substantially transversely to an airflow generated by forward movement of the vehicle, said first aerofoil having an arcuate portion projecting forwardly from the vehicle or part thereof with upper and lower regions extending from the arcuate portion toward the vehicle or part thereof, and
a second aerofoil, orientated substantially transversely to said airflow and substantially parallel to, and above and trailing said arcuate portion of the first aerofoil,
   configured such that said airflow interacts with the aerodynamic device and at least a portion of said airflow is diverted between the first and second aerofoils.

Preferably, said second aerofoil is cambered. with a cross-section substantially corresponding to the curvature of the adjacent first aerofoil upper region and arcuate portion.

A key advantage provided by the second aerofoil is a reduction in drag due to the shaping of the airflow from the aerodynamic device over the vehicle or part thereof to assist in maintaining a laminar airflow for a greater distance relative to a single aerofoil. The second aerofoil effectively acts in a comparable manner to leading edge slots found in aeronautical applications, such as aircraft wings, which broaden the airflow velocity envelope over the first aerofoil. However, in prior art aircraft systems, leading edge slots are typically employed in a high angle-of-attack flight mode (take-off, landing) in order to compensate for the loss of lift due to the reduced airspeed. In contrast the present invention is typically mounted at a fixed angle of attack and derives benefit from the reduction in drag achieved by maintaining laminar airflow over the upper surface of the vehicle.

Prior art aerodynamic aids utilising a single aerofoil akin to the said first aerofoil of the present invention suffer from two drawbacks, namely:
1. the incorporation of enlarged vertical endplates which project above upper surface of the vehicle, and
2. the increased drag incurred by an earlier transition to non-laminar airflow over the vehicle upper.

The function of the prior art vertical end-plates is prevention of turbulent airflow bleed around the ends of the aerofoil and thus must rely on projecting above the aerofoil in order to be effective. Unfortunately, this contravenes the legislative requirements in many countries regarding maximum vehicle dimensions, making fitment illegal or at least incurring the inconvenience of obtaining special dispensations or the like.

The present invention addresses both the aforesaid drawbacks. Moreover, the efficiency of the present invention in drag reduction is further enhanced by addition of the following optional features.

According to a further aspect, the present invention provides an aerodynamic aid substantially as described herein, wherein said first and second aerofoils are joined at both transverse distal ends by respective end-caps bounding the vertical separation between the two aerofoils.

Preferably, said end-caps are positioned to not extend above the upper periphery of the first and/or second aerofoil. Thus, fitment of the aerodynamic aid is possible to a range of standard trucks, trailers, stock trucks and the like. Moreover, the airflow accelerated through the slot between the first and second aerofoils generates low pressure relative to adjacent airflow.

Preferably, the first and/or second aerofoil may have an adjustable angle-of-attack. Providing such an adjustable aerofoil can provide the user with the ability to change the aerofoil to accommodate different shaped and sized vehicles and/or to adjust the airflow profile to minimise drag.

In a further embodiment the first and/or second aerofoil is pivotally coupled to the end-caps such that the inclination of the first and/or second aerofoils with respect to the vehicle can be adjusted so as to adjust the angle-of-attack of the aerofoil. It should be appreciated that the coupling between aerofoils and/or between a said aerofoil and the vehicle may take any form though preferably includes a hinge, axle, resilient connection or the like.

In a further embodiment, the pivotally coupled first and/or second aerofoil may include an actuator for pivoting the aerofoil. The actuator may include manual, powered or automatic cam mechanisms, hydraulic or pneumatic rams or the like.

In a yet further embodiment the actuator is configured to automatically pivot the aerofoil in response to signals received from one or more airflow sensors. A dynamically controlled aerofoil may thus be provided to change the angle-of-attack of the aerofoil in response to changes in airflow, thus ensuring the optimum configuration for reducing drag.

According to a further aspect of the present invention, each end cap incorporates a recessed or re-entrant portion between the first and second aerofoils and orthogonal to said transverse orientation of the aerodynamic aid.

As is well understood in the art, the tip portions or trailing edges of moving bodies such as wings, aerofoils and the like generate counter-rotating vortices with a rotational axis parallel to the airflow direction. The movement of bluff bodies such as trucks, trailers and the like causes the airflow along the vehicle sides to pass along the length of the vehicle and also cause the upper portion of the airflow to be drawn upwards towards the longitudinal boundary between the sidewall and the upper roof surface. Typically, this airflow interface is turbulent and often chaotic, inducing drag as the two airflows interact and merge.

Furthermore, when the moving vehicle is turning and/or travelling through a moving airflow (i.e. wind) there will also be a resultant effective wind direction located at an angle to the longitudinal axis of the vehicle. This causes an effect known as ‘lee-side drag’, whereby airflow spills across the vehicle body.

Superimposed on this turbulent airflow interface is the natural tendency (as referenced above) for two contra-rotating vortices to form, both rotating inward from the sidewall toward the centre of the roof surface.

The net drag experienced by the vehicle may be reduced by managing the airflow across this roof surface/sidewall boundary to reduce the turbulent portion of the airflow and maximise the non-turbulent vortex portion. Thus, according to a further aspect of the present invention said recessed or re-entrant portion of said end caps is at least partially arcuate, configured to deflect and constrain said airflow in a rotating path. Thus, the recessed portion when viewed from the direction of said airflow may be configured to curve downward from the upper surface of the first aerofoil and then continue curving upwards until meeting the lower surface of the upper aerofoil. Although such a configuration provides an aerodynamically enhanced treatment of the airflow at the lateral tips of the first and second aerofoils, the effectiveness may be further improved by addition of aerodynamic side rails located along the bluff body.

According to a further preferred embodiment, the present invention further includes at least one elongated aerodynamic side rails which extend rearwardly from the distal ends of the aerodynamic aid along the length of the vehicle or part thereof.

Preferably, the rails may be configured to be parallel to an airflow generated by forward movement of the vehicle.

In some preferred embodiments the rails may be configured for fitment to an elongated exterior apex or other protrusion on a vehicle or part thereof.

According to one aspect of the present invention, at least one said aerodynamic side rail includes:
an upper portion configured as an elongated third aerofoil orientated with transverse-leading and transverse-trailing edges extending substantially parallel to the longitudinal axis of the vehicle and the airflow generated by forward movement of the vehicle
a lower portion, configured as an elongated mounting attachable to said vehicle body.

In prior art configurations, vectored airflow from one side of the vehicle across the roof area of a vehicle with standard right-angled or radiused upper apices is able to mix on the lee side and cause lee-side drag. The aerodynamic side rails of the present invention attenuate this drag by virtue of the interaction of the airflow with the third aerofoil. Although the chord of the third aerofoil orthogonal to the longitudinal vehicle axis is fixed and may be made comparatively short, the effective chord ‘seen’ by the airflow is considerably longer.

The effective third aerofoil chord is given by a cross-section taken at the effective vectored angle of the airflow resulting from both the forward vehicle movement and any lateral airflow component, either from the turning movement of the vehicle and/or environmental airflows. In addition to a longer chord, the effect of the oblique airflow travel over the third aerofoil is to lower its effective camber. Axiomatically, the air pressure of the airflow over the third aerofoil is lowered as an innate function of aerofoil dynamics thus generating a high velocity, low pressure line parallel with the longitudinal axis of the vehicle, which effectively constrains the otherwise turbulent airflow within the above-referenced low pressure rotating vortex flow generated by the aerofoil shape. Any airflow which does leak across the vehicle roof encounters the corresponding contra-rotating low pressure line region which also acts to constrain the airflow and prevent it from passing over to the lee-side.

To further aid the oblique vectored airflow across the third aerofoil, spacing struts may be positioned beneath the aerofoil for attachment to the vehicle or part thereof so as to both provide structural support and aerodynamic airflow management assistance.

Thus, according to one embodiment, said aerodynamic side rail third aerofoil is attached to the vehicle or part thereof by one of more spacing struts. Preferably, at least one strut is configured as a foil extrusion with an angle of attack substantially aligned with the typical vectored airflow direction.

Preferably a plurality of said struts are congruently aligned to deflect airflow inward to the center of the vehicle and regularly spaced along the aerodynamic side rail. Preferably the rearmost strut is conversely orientated to deflect airflow outward away from the vehicle thus outwardly deflecting the terminal region of the airflow along the vehicle upper body vertices aides in inducing corresponding vortices and avoiding problematic chaotic drag.

In one embodiment, the aerodynamic side rails are formed as a structural extrusion fitted into a correspondingly depressed portion of the vehicle body upper vertices. Thus, in applications such as stock or freight trucks, the conventional corner rails running along each of the upper side/roof longitudinal interface may be replaced with aerodynamic side rails. Moreover, it will be readily apparent that a range of structural components or bodies exposed to detrimental drag in an airflow, e.g., trains, boats, and the like would also potentially benefit from fitment of said aerodynamic side rails.

Yet further drag reductions are possible by the utilization of a further aerodynamic aid. The aforementioned rear panel drag is generated immediately aft of the rear-most panel of the vehicle caused by the turbulence of the airflow adjacent the side and roof panels of the vehicle mixing with the already turbulent airflow exiting from under the vehicle. Considering a substantially square/rectangular shaped rear panel configuration, the airflow passing over the rearward edge of the truck would typically pass around the rearmost edge towards the centre of the rear panel in a chaotic turbulent flow extending, or ‘adhering’ substantially across the width of the rear panel extending rearward, thus forming a drag cone.

Thus, according to a yet further aspect, the present invention may provide one or more rearward body extension elements, attachable to the rear-most portion of the vehicle body, said extension elements being movable between a folded position flush with an exterior surface of the vehicle body and an extended position projecting rearward from the rear panel.

Preferably, at least one extension element is attached at an offset position inward from a rear panel peripheral edge, preferably parallel to said edge.

In one embodiment, the extension element(s) is/are rectangular plate(s), hinged along a longitudinal edge to the rear vehicle panel and rotatable in said extended position to be orientated substantially orthogonal to said rear panel and substantially parallel to the airflow.

Offsetting or ‘indenting’ the extension plates inwards from the rear panel edges effectively gives both:
a reduced area for the formation of the turbulent flow ‘adhering’ to the rear of the vehicle and
an extension of the departure point of the trailing edge turbulence to a greater rearward position.

In a preferred embodiment where the vehicle or part thereof comprises more than one body, for example a tractor unit and one or more coupled trailer units, further detrimental drag is generated by airflow passing between the tractor unit and trailer (and between any subsequent trailers) due to mixing of the airflows on both sides of the vehicle. This may occur from vectored airflows (as the vehicle turns and/or from off-axis environmental airflows) or during normal travel with longitudinal airflow. The use of the term bodies as used hereafter is used to aid clarity of explanation only, it should be apparent that the term bodies might refer to a tractor unit and coupled trailer unit, or any number of trailer units coupled together, train carriages, or any other coupled vehicle or part thereof that might be susceptible to induced drag due to cross flow mixing between said coupled bodies.

In a yet further embodiment, the present invention provides at least one screen attachable at an interface between coupled bodies.

Preferably, said screens are orientated in a substantially vertical plane, and preferably both span the gap between and extend vertically over the height of said bodies.

In one embodiment, said screens are attached along the central longitudinal axis of the coupled bodies, whilst in an alternative embodiment, a pair of screens are attachable one on each side, between two substantially co-linear (when the bodies are not angled with respect to each other) sides of the coupled bodies. To provide the maximum benefit, it will be appreciated that the screens should extend to the maximum extent permissible within the constraints of the coupling between bodies. Locating a single screen along the longitudinal centreline between bodies circumvents the difficulty of variation in the distance between the co-linear edges of the bodies as the vehicle turns. Such variations may be accommodated in a variety of methods including resilient screen material, resilient attachments (e.g. springs) and the like or slideable attachment methodologies to either the bodies themselves or between screen sections.

The aforementioned screens aid drag reduction by preventing cross flow mixing between the airflows on both sides of the vehicle. Any airflow directed between the tractor unit and trailer or between trailers is forced away taking the path of least resistance away from the higher pressure flow (and usually hotter due to the radiator wash, engine and exhaust) underneath the vehicle. The airflow is thus directed upwards and to the upper extent of the screen and is then swept into the main directional flow along the vehicle upper until exiting from the rear-most position.

The present invention also includes a yet further embodiment, particularly adapted for stock trucks and other means of transporting livestock.

According to a further aspect of the present invention there is provided a vehicle or part thereof, wherein the lateral sides of the vehicle or part thereof, include one or more aerodynamic ventilation assemblies orientated at an inclination from vertical upon a lateral side of said vehicle, each said assembly including:
a forward deflector rail, positioned substantially proximal with the body surface shaped to perturb or deflect the airflow outwards by a predetermine extent;
an intermediate planar separating strip substantially flush with the body surface, and
a rearward collector rail, positioned on the opposing side of the intermediate separating strip to the forward deflector rail and orientated substantially parallel to the forward deflector rail;
   said rearward collector rail being an extrusion having an arcuate cross section with an opening on a forward leading edge leading to an enclosure within said arcuate extrusion.

Preferably, said forward deflector rail, intermediate planar separating strip and rearward collector rail are formed as an integrated assembly from a single continuous extrusion.

Preferably, the ventilation assemblies extend substantially between topmost and lowermost vertical extremities of the vehicle sides. It will be readily appreciated that the intermediate planar separating strip may simply be a portion of the body surface, rather than a separate layer fitted over the body surface.

Preferably, the ventilation assemblies are inclined from the vertical from a lower position towards the vehicle front, upwards to a higher position towards the vehicle rear. The converse inclination is also possible, though less desirable.

Preferably, said opening extends substantially along the length of the collector rail forming a slot between the separating strip/body surface and the collector rail.

Preferably, said rearward collector rail cross-section curves outwards and forwards from said slot, away to a point of maximum displacement from the body surface before curving forward and inward toward the body surface.

Preferably, said predetermined extent substantially corresponds to said point of maximum displacement.

As previously discussed, the airflow adjacent the sides of a bluff body vehicle is sheared whereby airflow immediately adjacent the sidewall adheres to the sidewall and is effectively stationary with respect to the vehicle, while the airflow velocity increases as the lateral separation form the sidewall increases.

The collector rail and associated slot project laterally to an extent sufficient to interact with the moving airflow, thereby diverting a portion of the airflow into said slot. Moreover, the smooth curved outer surface presents a cambered surface to the airflow, causing the airflow to adhere to the surface and pass into the path of the adjacent/subsequent ventilation assembly, increasing the relative airflow across the otherwise substantially stationary airflow adjacent the sidewall surface.

Furthermore, inclining the ventilation elements (typically at 55 degrees, for typical stock trucks) also presents a longer effective chord to the airflow across the outer surface of the collector rail. The larger chord consequently generates a Reynolds number more effective for the range of airspeeds likely to be encountered by a typical stock truck (at speed >approx. 100 km/h). The inclined collector rails also act to direct airflow retained by the slot within the collector rail to pass upwards towards the roof section.

Preferably, said planar separating strip includes one of more apertures extending into the body interior. The ascending airflow may thus pass into the vehicle via the apertures.

According to one aspect, said apertures include an angled deflector portion, orientated to deflect airflow into said vehicle.

Preferably, said deflectors transversely span the separation between the front and rear rails, and more preferably orientated with a lower distal portion projecting outwards from the sidewall from an upper proximal attachment point.

This aspect of the present invention has particular application to stock trucks/trains and/or stock containers/crates. The stock containers/crates may be integral with the truck/trailer/rail wagon or may be temporarily supported by a deck of a truck/trailer or rail wagon assembly.

In applications with stock trucks with multiple internal stock decks or floors, the apertures are preferably located adjacent the level of each deck.

The airflow into the vehicle interior may exit via the roof (for vehicles with a webbing roof or the like) and/or via outlets in the rear panel. Such outlets prevent egress of stock effluent through the ventilation assembly apertures.

Although a portion of the aforementioned heated turbulent airflow under the vehicle is able to exit via the vehicle sidewalls, there is less resistance to flow exiting via the rear of the vehicle. This flow is relatively low pressure in comparison to airflow exiting rearward from the sidewalls and roof of a bluff body vehicle. Consequently, a low-pressure triangular region is formed across the face of the rear panel of the vehicle with the triangle base substantially congruous with the lower edge of the rear panel, with the apex of the triangle region located along the rear panel centerline approximately at the panel's geometric center.

The triangular region thus provides an advantageous region for the placement of airflow egress outlets. Preferably, said rear panel includes one or more airflow egress outlets positioned within a substantially triangular region bounded by the lowermost portion of the rear panel and a vertex substantially at the geometric centre of the rear panel. To maintain the triangular region at low-pressure, the adjacent portion of the rear panel are preferably formed as imperforate sections. Similarly the sidewall sections from the base of the sidewall to a vertical height substantially equivalent to said triangle apex are also imperforate, together, preferably, with a portion of the roof panel adjacent the rear panel. The rear panel airflow egress outlets thus act in synergistic combination with the aforementioned rearward body extension elements to ensure a low-pressure region.

A kit of aerodynamic parts for vehicle or part thereof wherein the kit comprises a leading edge aerofoil (or components for constructing same) substantially as described above and one or more of the following parts:
An elongated aerodynamic side rail which extends rearwardly from the distal ends of the aerodynamic aid along the length of the vehicle or part thereof;
A rearward body extension element (or components therefor), attachable to the rear-most portion of the vehicle body;
At least one screen attachable at an interface between a coupled vehicle and trailer and/or between coupled trailers.

The present invention thus provides several advantageous features and implementations to address the detrimental effects of drag, particularly on bluff sided bodies and vehicles such as freight trucks, truck and trailer combinations and stock trucks. Beneficial effects may be derived both using the individual embodiments and aspects of the present invention individually or collectively.

### BRIEF DESCRIPTION OF DRAWINGS

Further aspects of the present invention will become apparent from the following description which is given by way of example only and with reference to the accompanying drawings in which:

FIG. 1. shows a prior art side elevation of a truck and trailers with high drag creation regions;

FIG. 2. shows a prior art side elevation of two coupled trailers showing the combined effects of drag creation;

FIG. 3. shows a plan view of prior art plan elevation of a truck and trailers showing lee-side drag creation regions;

FIG. 4. shows first embodiment of the present invention of a perspective view of a first aerodynamic aid and aerodynamic side rails;

FIG. 5. shows a side elevation (and partial section) view of the embodiment shown in FIG. 4;

FIG. 6. shows an enlarged side elevation view of the embodiment shown in FIG. 5;

FIG. 7. shows a plan elevation of a the embodiment shown in FIG. 4 sectioned along the vehicle centerline;

FIG. 8. shows a front section view through the first aerodynamic aid of the embodiment shown in FIGS. 4-7

FIG. 9. shows a sectioned front side elevation view of the aerodynamic side rails shown in FIG. 4 and FIG. 6;

FIG. 10. shows a perspective view of extension elements in an extended position from the rear panel of a trailer according to a further aspect of the present invention

FIG. 11. shows a): a plan view of prior art airflow drag around the rear of a vehicle and b): a plan elevation view of the airflow about the embodiment shown in FIG. 10;

FIG. 12. shows a perspective view of a truck and trailers showing a further aspect of the present invention in the form of screens located between the truck and trailers;

FIG. 13. shows a plan section view of an aerodynamic ventilation assembly according to a further aspect of the present invention;

FIG. 14. shows a perspective view of the aerodynamic ventilation assembly shown in FIG. 13, and

FIG. 15. shows a perspective view of the rear of a trailer including the aerodynamic ventilation assemblies shown in FIGS. 13-14 and airflow egress outlets in the rear panel.

FIG. 16. shows a transverse cross-section of an alternative embodiment of an aerofoil used in the first aerodynamic aid shown in FIGS. 4 and 5.

### BEST MODES FOR CARRYING OUT THE INVENTION

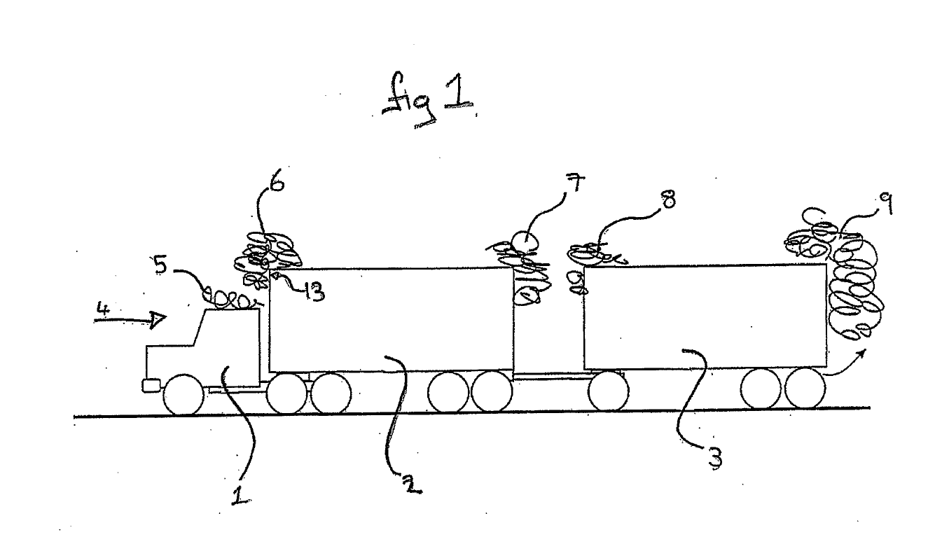

The present invention (100) of an aerodynamic aid is illustrated with respect to FIGS. 1-8 in respect of applications to trucks and trailers, particularly stock trucks. It will be readily appreciated however that this is purely exemplary only and that the invention is not restricted to same.

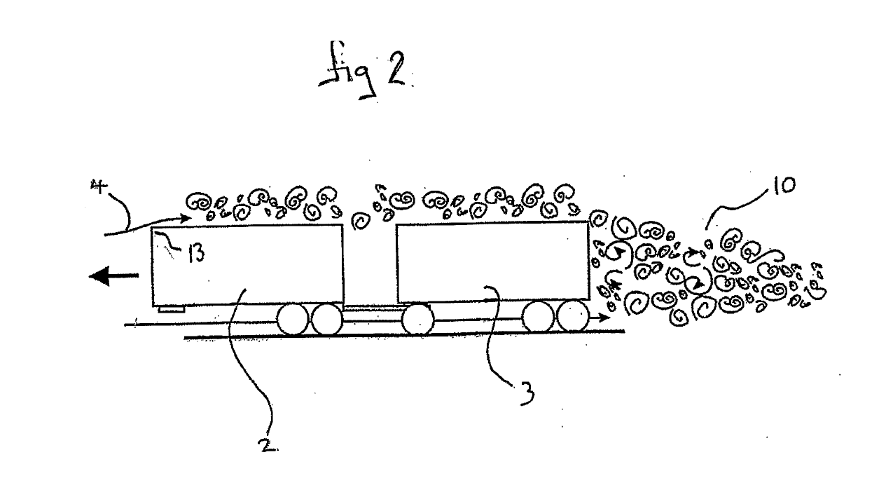

FIGS. 1-3 collectively show the drag associated with prior art configurations for truck (1) and trailer (2, 3) combinations. As shown in FIG. 1, the airflow (4) caused by the vehicle movement in a forward direction generates turbulent drag (5-10) at the front and rear interface of each bluff shaped truck (1) and trailer (2, 3) bodies respectively. The cumulative generated drag (i.e. ‘Front side’, ‘Leeside’, and ‘Side wall’ drag) merges (shown in FIG. 2) in a chaotic mixing that passes along the length of the trailers (2, 3) and extends (as ‘Rear Panel drag) for a distance behind the rearmost portion of the rear trailer (3) in a drag ‘cone’ (10).

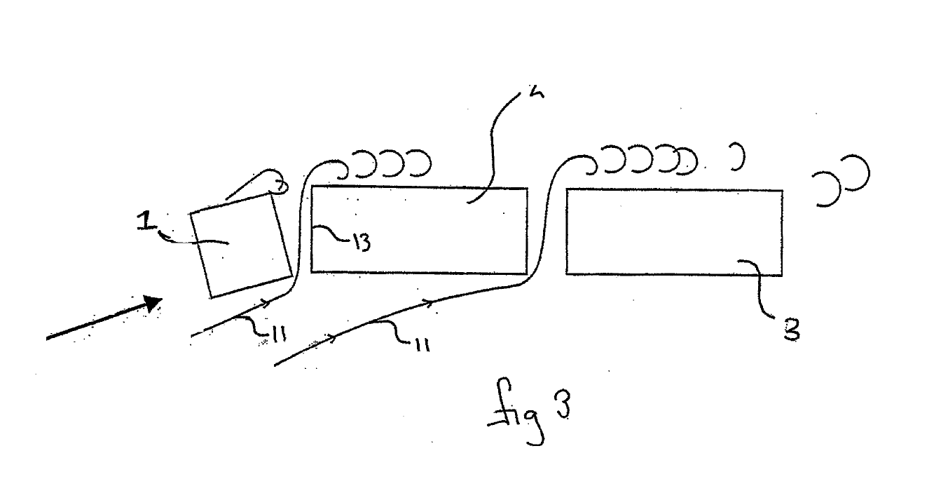

Side winds and/or the effects of the truck (1) turning generate a vectored airflow (11) (as shown in FIG. 3) passing across the top of the vehicle and between the truck (1) and trailer (2) and between the two trailers (2, 3). The present invention provides a plurality of aerodynamic aids to reduce the induced drag. As previously iterated, the terms denoting orientation such as “forward”, “upper”, “lower”, “leading edge” and the like are defined with respect to the present invention in use, fitted to a moving vehicle.

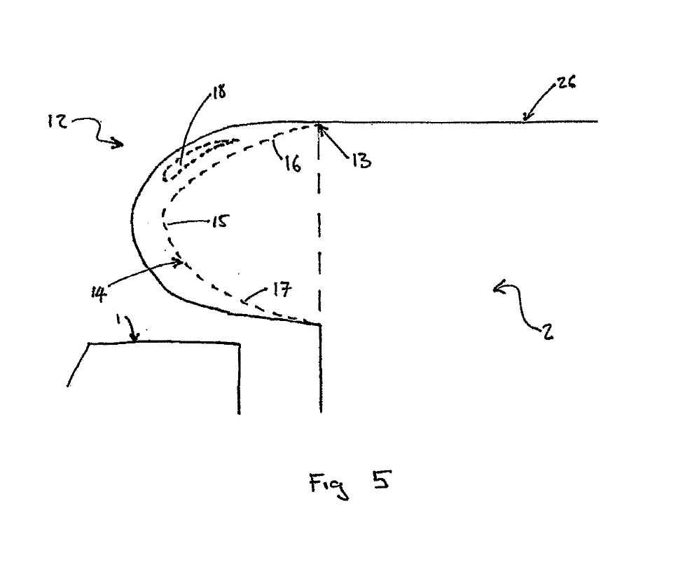

FIGS. 5-7 show a first preferred embodiment of the present invention (100), in the form of a leading edge aerodynamic aid (12) locatable at an uppermost leading edge (13) of the lead trailer (2). It will be understood however, that the aid may also be fitted to trucks with fixed cargo areas which project above the truck cab. The aid (12) includes a first aerofoil (14) extending transversely to the airflow (4) substantially spanning the width of the trailer (2) an arcuate portion (15) projecting forwardly from leading edge (13) with upper (16) and lower (17) portions extending from the arcuate portion (15) to the vehicle trailer body (2). Such a configuration closely mirrors known prior art systems as previously described. However, the preferred aerodynamic aid (12) also includes a second aerofoil (18) orientated parallel to, and above and rearward of said first aerofoil leading edge (14). The combined effect of the aid (12) is the diversion of a portion of the airflow (4) between the two aerofoils (14, 18), which helps produce a reduction in the generated drag due to the shaping of the downstream airflow to assist in maintaining a laminar airflow for a greater distance than otherwise produced with a single aerofoil.

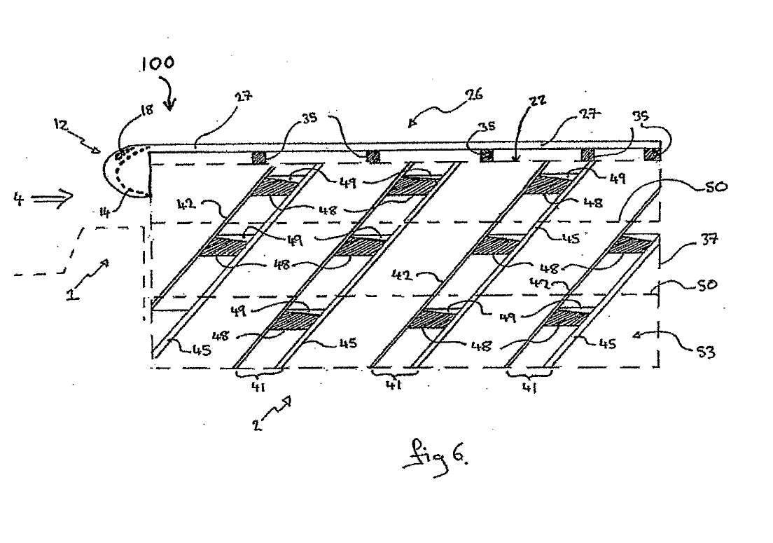

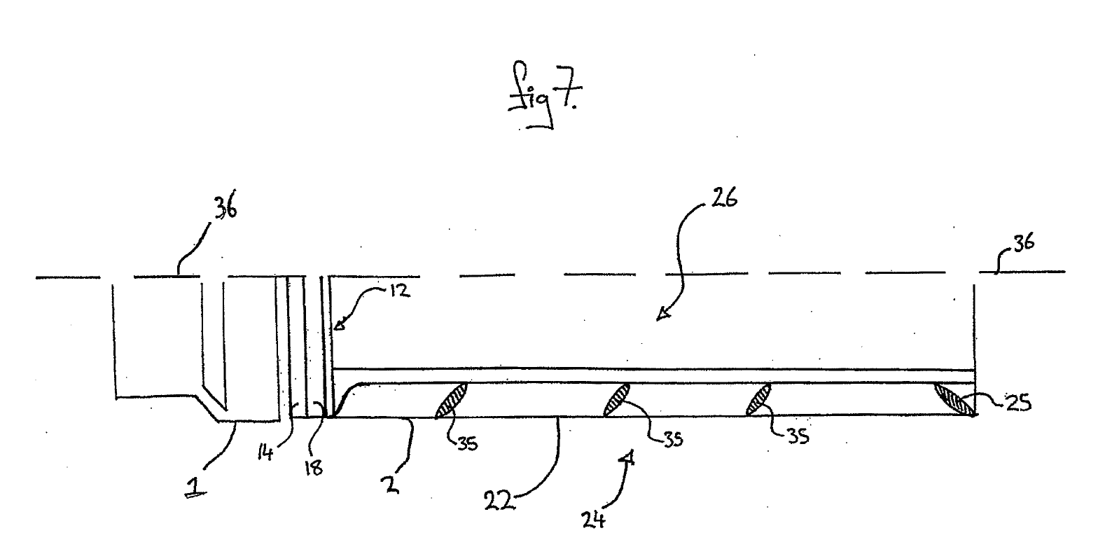

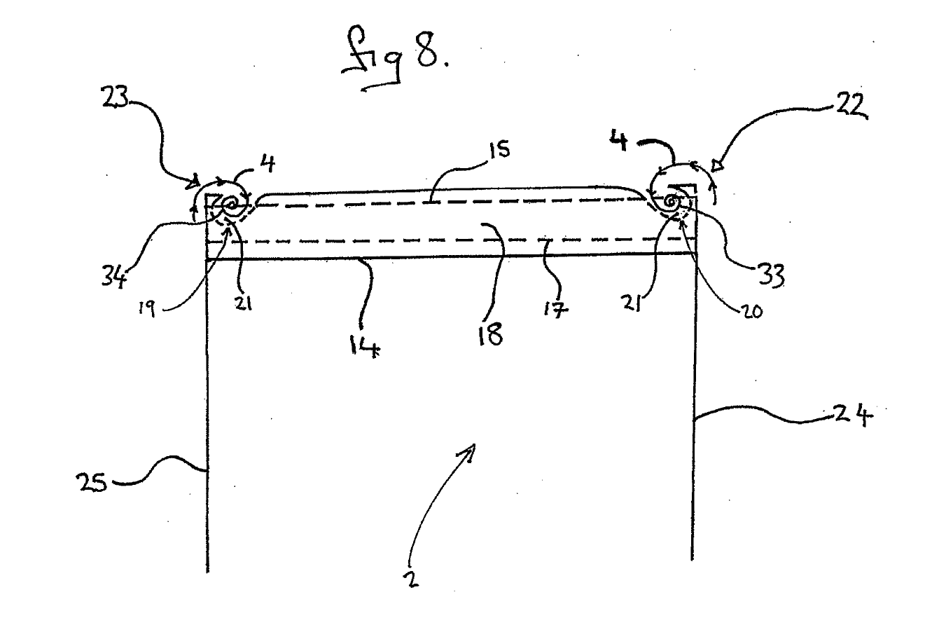

FIG. 6 also shows a second aspect of the present invention (together with FIGS. 7-8), wherein the first and second aerofoils (14, 18) are joined at their distal ends by respective end-caps (19, 20). The end-caps (19, 20) do not extend above the upper periphery of the first and/or second aerofoil (14, 18), thus circumventing legislative restrictions for vehicle height limits. The aerodynamic aid (12) may also be readily fitted to a range of standard trucks, trailers, stock trucks and the like. The end-caps (19, 20) also provide an impediment for the low-pressure, high velocity airflow passing between the aerofoils (14, 18) bleeding around the ends to merge with the adjacent higher pressure air-flow. The end caps (19, 20) each incorporate a recessed or re-entrant portion (21) between the first (14) and second aerofoil (18) orthogonal to the airflow (4). This helps define and locate the contra-rotating tip vortex generated at both upper lateral edges (22, 23) of the trailer (2).

As previously discussed, the movement of bluff bodies such as trucks, trailers and the like, causes the upper portion of the airflow (4) along the vehicle sides to be drawn upwards towards the longitudinal vertices (22, 23) between the sidewalls (24, 25) and the upper roof surface (26). Furthermore, any vectored airflow (4) from off axis wind and/or turning of the vehicle causes the aforementioned ‘lee-side drag’ to be superimposed on the two contra-rotating vortices rotating inwardly from the sidewall (24, 25) toward the centre of the roof surface (26).

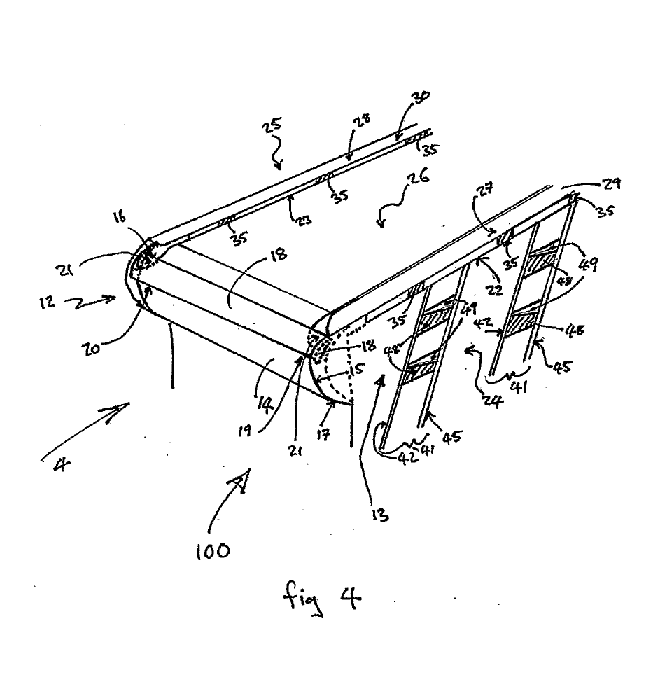

The resulting drag is reduced by managing the airflow (4) across this roof (26)—sidewall (24, 25) boundary to minimise the turbulent portion of the airflow and maximise the non-turbulent vortex portion. The recessed or re-entrant portion (21) of each end cap (19, 20) is arcuate, configured to deflect and constrain said airflow in a rotating path precipitating a rotating vortex. As shown in FIGS. 4 and 8, the recessed portion (21) viewed from the direction of said airflow curves downward from the upper surface of the first aerofoil (16) before curving upwards until meeting the lower surface of the upper aerofoil (18).

A further aspect of the present invention (100) (shown in figures—4, 6, 7, 8, and 9) comprises elongated aerodynamic side rails (ASR) (27, 28) respectively fitted to each exterior apex (22, 23) of each trailer (2, 3).

The complementary ASRs (27, 28) on each vehicle body are positioned orthogonal to, and in intimate contact with, the end caps (19, 20) respectively. The ASRs (27, 28) each include an upper portion and lower portion. In the embodiment shown, the upper portion is an elongated third aerofoil (29) orientated with leading (30) and trailing edges (31) extending parallel to the longitudinal axis of the trailer (2, 3). The lower portion is an elongated mounting (32) attached to the apices (22, 23) parallel to the third aerofoil section (29).

The air pressure of the airflow (4) over the third aerofoil (29) is lowered with respect to the adjacent airflow (4) as an innate function of aerofoil dynamics generating a high velocity, low pressure line parallel with the longitudinal apices (22, 23). This low-pressure line (not explicitly shown), constrains contra-rotating vortices (33, 34) generated by end caps (19, 20) as illustrated in FIG. 8.

The third aerofoil (29) of each ASR (27, 28) is spatially separated from said mounting (32) by streamlined spacing struts (35), orientated to deflect the airflow (4) inwards to the vehicle centerline (36). The struts (35) are shaped as foil extrusions with an angle of attack substantially aligned with the direction of the typical vectored airflow (4).

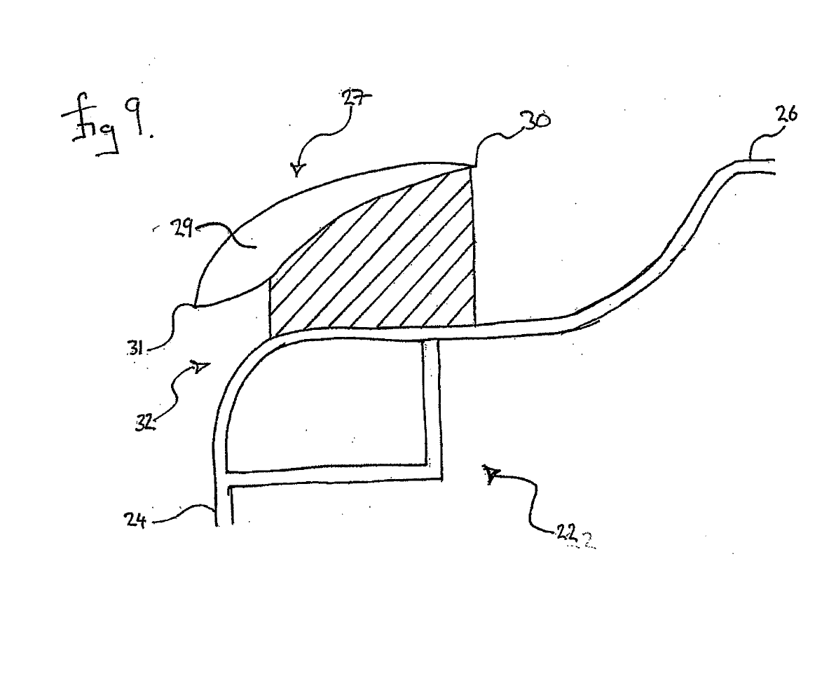

In contrast to all the preceding struts (35), the rearmost strut (25) is conversely orientated to deflect airflow outward away from the vehicle centerline (36). This provides a specific generation point to instigate the induction of further trailing vortices behind the vehicle. As may be readily seen in the embodiments shown in FIG. 9, an ASR (27) may be formed as a structural extrusion for use as the structural corner rail for the trailers (2, 3) in place of the existing structures without exceeding the existing overall vehicle height.

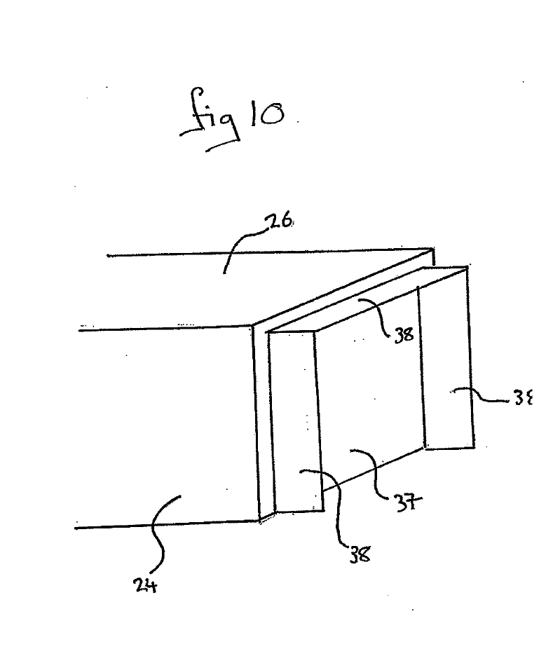

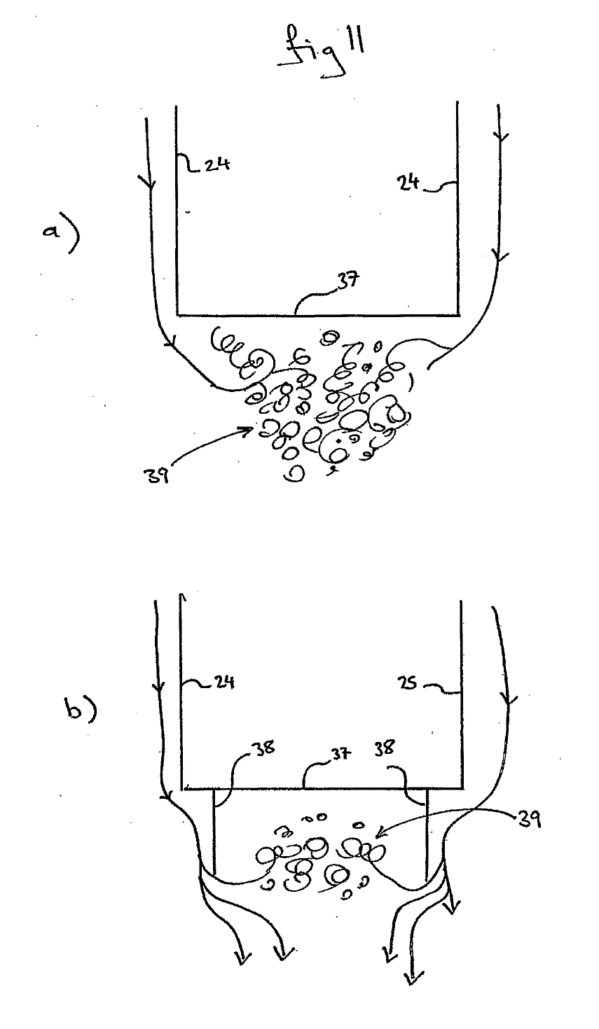

FIGS. 10 and 11 shows a yet further aspect of the present invention configured to reduce the aforementioned ‘rear panel drag’ generated immediately aft of the rear-most vehicle panel (37), extending rearward forming a drag cone. Three rearward body extension elements (38) are attached to the rear-panel (37). Each element (38) is movable between a folded position (not shown) flush with the rear panel (37) or side walls (24, 25) and an extended position (shown in FIG. 10) projecting rearward substantially orthogonally from the rear panel (27). The extension elements are attached to the rear panel (37) at an inwardly offset position, parallel to the peripheral edges. As shown in FIG. 11 in comparison with the existing configuration (FIG. 11 a) offsetting or ‘indenting’ the extension plates inwardly from the edges of the rear panel (37) (FIG. 11 b)) reduces the area of the rear panel (37) for the formation of the turbulent flow (39) ‘adhering’ to the rear panel (37) and provides a rearward extension of the departure point of the trailing edge turbulence to further reduce the resultant drag.

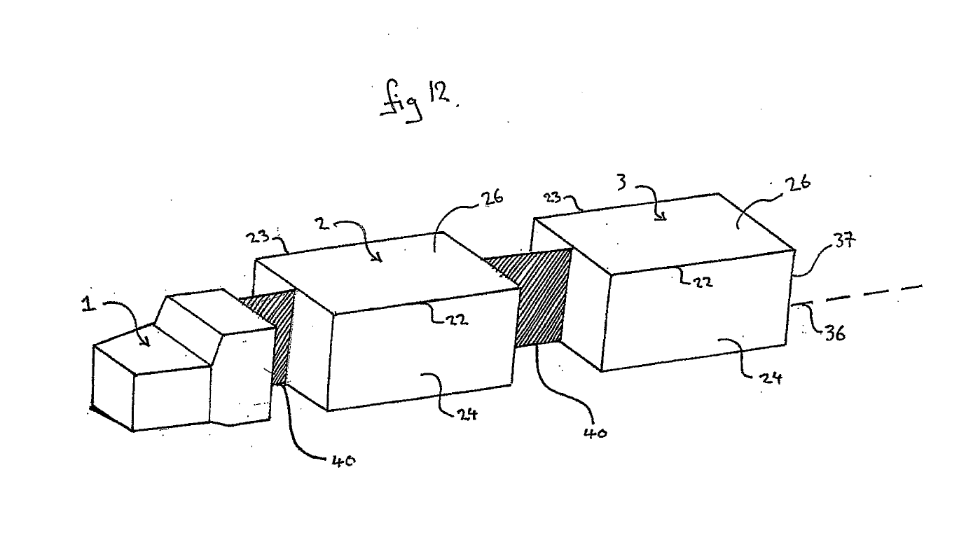

To mitigate the effects of the aforementioned detrimental drag caused by airflow passing between the truck (1) and trailer (2) (and between any subsequent trailers (2, 3)), the present invention provides yet a further embodiment as shown in FIG. 12. A screen (40) is attached at each interface between the truck (1) and trailer (2) and/or between trailers (2, 3). The screens (40) shown are orientated in a substantially vertical plane, and extend along the majority of the vehicle/trailer (1, 2, 3) height.

In the embodiment depicted in FIG. 12, said screens are attached along the vehicle's central longitudinal axis (36), whilst in an alternative embodiment, a pair of screens are attachable between the vehicle/trailer interface along two opposing lateral sides (22, 23). As will be readily appreciated, the screens (40) ideally should extend to the maximum vehicle extent permissible within the constraints of the vehicle coupling. The screens (40) aid drag reduction by preventing mixing between the airflows on both vehicle sides (24, 25).

FIGS. 6 and 13-15 show a yet further embodiment adapted for stock trucks and other means of transporting livestock.

The lateral sides (24, 25—only 24 being visible in FIGS. 6, 13-15) include a plurality of inclined (from the vertical from a lower position towards the vehicle front, upwards to a higher position towards the vehicle rear) aerodynamic ventilation assemblies (41), each including;
an elongated forward deflector rail (42), positioned close to the sidewall (24) shaped to deflect the airflow (4) outwards by a predetermined extent (43);
an intermediate planar separating strip (44) substantially flush with the body surface (24), and
a rearward collector rail (45), positioned on the opposing side of the separating strip (44) to the forward deflector rail (42) and orientated substantially parallel to the forward deflector rail (42).

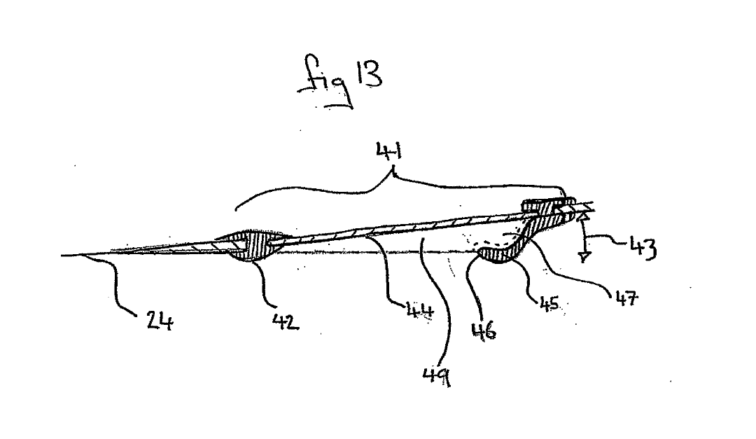

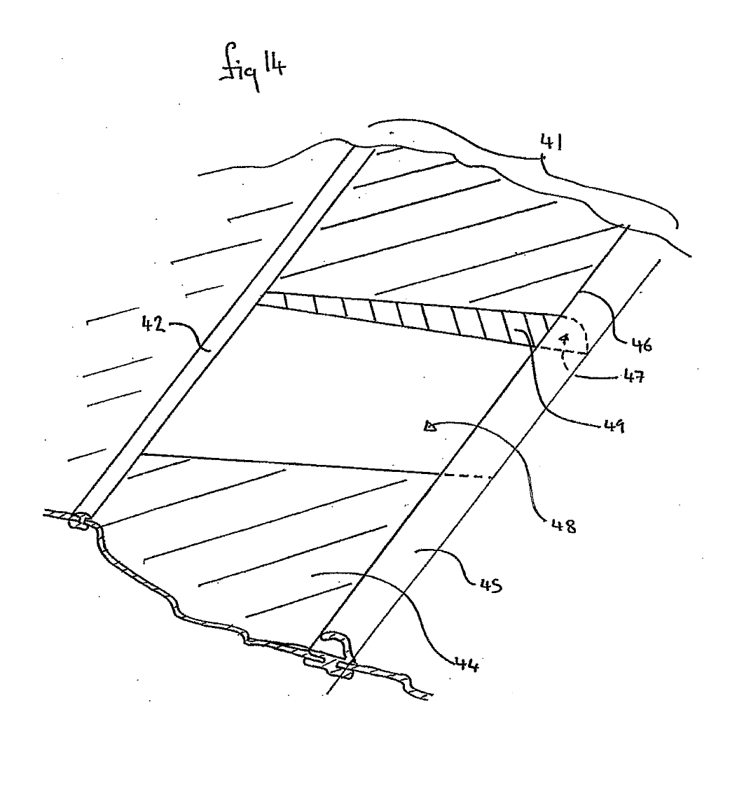

As shown in FIGS. 13-14, each collector rail (45) is an extrusion having an arcuate cross section with an opening on a forward leading edge (46) (forming a slot) leading to an enclosure (47) within said arcuate extrusion.

The deflector rail (42), planar separating strip (44) and collector rail (45) are readily formed as an integrated assembly from a single continuous extrusion.

As shown in FIG. 6, the ventilation assemblies (41) extend between the vertical extremities of the vehicle side (24), though it will be readily appreciated that the planar separating strip (44) may simply formed as be a portion of the side wall (24), rather than a separate layer/extrusion fitted over the side wall (24).

As can be discerned in FIGS. 13 and 14, the rearward collector rail (45) cross-section curves outwards and forwards toward said slot to a maximum displacement (substantially corresponding to said predetermined extent (43)) from the side wall (24) before curving forward and inward toward the side wall (24).

As previously discussed, the airflow adjacent the sides of a bluff body vehicle is effectively stationary with respect to the vehicle. The collector rail (45) and associated slot project laterally sufficiently to interact with the moving airflow, located beyond the stationary airflow and thereby diverting a portion of the airflow into said slot. The smooth curved outer surface of the collector rail (45) presents a cambered surface to the airflow, thus causing the airflow (4) to adhere to the surface and pass into the path of the adjacent/subsequent ventilation assembly (41).

The separating strips (44) each include a plurality of apertures (48) extending into the body interior. The ascending airflow deflected by the inclined collector rails (45) may thus pass into the vehicle via the apertures (48). The apertures (48) also include an angled deflector portion (49), orientated to deflect airflow (4) into said trailer (2). As shown in FIG. 14 the deflectors (49) transversely span the separation between the front (42) and rear collector rails (45). In applications such as a stock truck as shown in FIG. 6, with multiple internal stock decks or floors (50) a separate set of apertures (48) are incorporated for each deck.

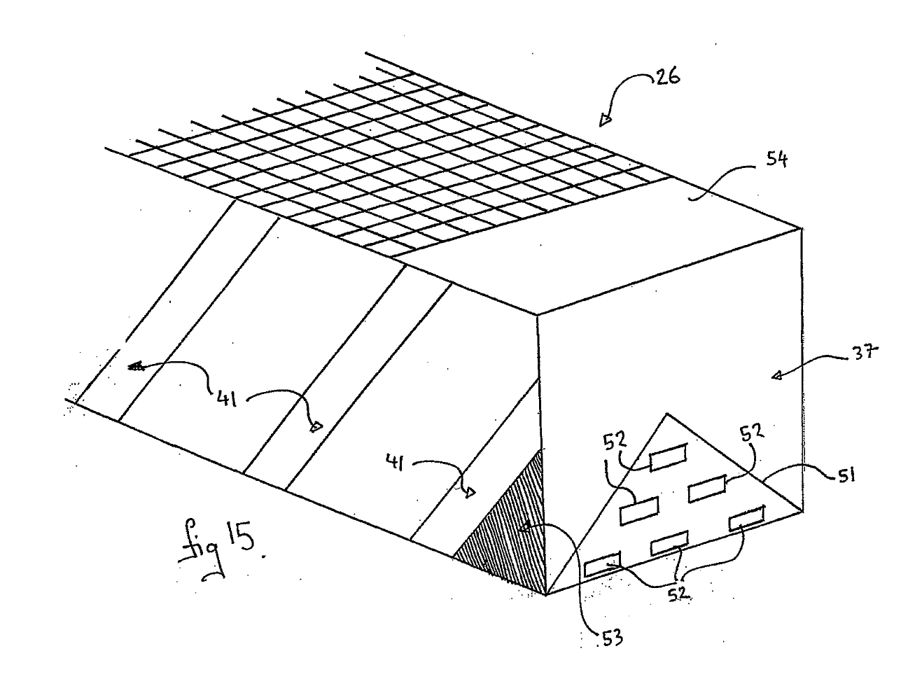

The airflow (4) into the trailer (2) interior may exit via the roof (26) (for vehicles as shown in FIG. 15 with a webbing roof or the like) and/or via outlets in the rear panel (37).

There is less resistance for the aforementioned heated turbulent airflow under the vehicle to exit via the rear of the vehicle than via the vehicle sidewalls (24, 25). Moreover, the rearward exiting airflow (4) is at comparatively low pressure to airflow exiting rearward from the sidewalls (24, 25) and roof (26). The resultant outcome is a low-pressure triangular region (51) located at the lower portion of the rear panel (37), ideally suited to the placement of egress outlets (52) for airflow (4) exiting the vehicle interior. Imperforate portions (53) and (54) of the sidewalls (24, 25) and roof (26) respectively located adjacent the rear panel (37) are formed as imperforate sections to maintain the relative low-pressure of triangular region (51).

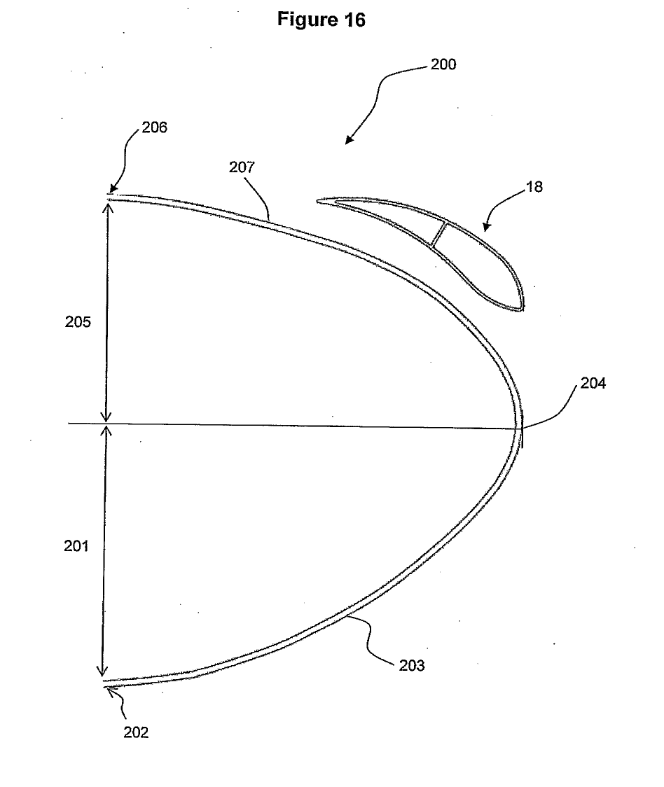

FIG. 16 shows an alternative embodiment of an aerofoil 200 for use as a replacement for the first aerofoil 14 shown in FIGS. 4 and 5. The aerofoil 200 differs from that of the aerofoil 14 in that the lower ‘vertical’ distance (201) from the lowest point (202) of the lower surface (203) to the most forward part (204) of the aerofoil (200) is less than the upper ‘vertical’ distance (205) from the upper point (206) of the upper surface (207) to the most forward part (204).

Aspects of the present invention have been described by way of example only and it should be appreciated that modifications and additions may be made thereto without departing from the scope of the appended claims.

1. A leading edge aerodynamic aid for a vehicle or part thereof, said aid being locatable at an uppermost leading edge of said vehicle and comprising:
a first aerofoil extending substantially transversely to an airflow generated by forward movement of the vehicle, said first aerofoil having an arcuate portion projecting forward of the vehicle body with upper and lower regions extending from the arcuate portion toward the vehicle body; and
a second aerofoil, oriented substantially transversely to said airflow and substantially parallel to, vertically adjacent and trailing said arcuate portion of the first aerofoil, configured such that said airflow interacts with the aerodynamic aid and at least a portion of said airflow is diverted between the first and second aerofoils; and wherein the first aerofoil substantially spans the width of the vehicle to which it is attached.

2. The aerodynamic aid as claimed in claim 1, wherein said first and second aerofoils are joined at both transverse distal ends by respective end-caps bounding the vertical separation between the two aerofoils.

3. The aerodynamic aid as claimed in claim 2, wherein the end-caps are positioned to not extend above the upper periphery of the first and/or second aerofoil.

4. The aerodynamic aid as claimed in claim 1, wherein the first and/or second aerofoil have an adjustable angle-of-attack.

5. The aerodynamic aid as claimed in claim 4, wherein the first and/or second aerofoil is pivotally coupled to the end-caps such that the inclination of the first and/or second aerofoils with respect to the vehicle can be adjusted so as to adjust the angle-of-attack of the aerofoil.

6. The aerodynamic aid as claimed in claim 5, wherein the pivotally coupled first and/or second aerofoil includes an actuator for pivoting the aerofoil.

7. The aerodynamic aid as claimed in claim 6, wherein the actuator is configured to automatically pivot the aerofoil in response to signals received from one or more airflow sensors.

8. The aerodynamic aid as claimed in claim 2, wherein each end cap incorporates a recessed or re-entrant portion between the first and second aerofoils and orthogonal to said transverse orientation of the aerodynamic aid.

9. A vehicle or part thereof which includes an aerodynamic aid as claimed in claim 1.

10. The vehicle or part thereof as claimed in claim 9, which includes at least one elongated aerodynamic side rail which extends rearwardly from the distal ends of the aerodynamic aid along the length of the vehicle or part thereof.

11. The vehicle or part thereof as claimed in claim 10, wherein the rails are configurable to be parallel to an airflow generated by forward movement of the vehicle.

12. The vehicle or part thereof as claimed in claim 10, wherein at least one said aerodynamic side rail includes:
an upper portion configured as an elongated third aerofoil oriented with transverse-leading and transverse-trailing edges extending substantially parallel to the longitudinal axis of the vehicle and the airflow generated by forward movement of the vehicle; and
a lower portion, configured as an elongated mounting attachable to said vehicle body.

13. The vehicle or part thereof as claimed in claim 12, wherein said aerodynamic side rail third aerofoil is attached to the vehicle or part thereof by one or more spacing struts.

14. The vehicle or part thereof as claimed in claim 13, wherein at least one strut is configured as a foil extrusion with an angle-of-attack substantially aligned with the typical vectored airflow direction.

15. The vehicle or part thereof as claimed in claim 14, wherein a plurality of said struts are congruently aligned to deflect airflow inward to the center of the vehicle and regularly spaced along the aerodynamic side rail.

16. The vehicle or part thereof as claimed in claim 15, wherein the rearmost strut is conversely oriented to deflect airflow outward away from the vehicle, thus outwardly deflecting the terminal region of the airflow along the vehicle upper body vertices aids in inducing corresponding vortices and avoiding problematic chaotic drag.

17. The vehicle or part thereof as claimed in claim 12, wherein the vehicle or part thereof includes one or more rearward body extension elements, attachable to the rear-most portion of the vehicle body, said extension elements being movable between a folded position flush with an exterior surface of the vehicle body and an extended position projecting rearward from the rear panel.

18. The vehicle or part thereof as claimed in claim 17, wherein the extension element(s) is/are rectangular plate(s), hinged along a longitudinal edge to the rear vehicle panel and rotatable in said extended position to be oriented substantially orthogonal to said rear panel and substantially parallel to the airflow.

19. The vehicle or part thereof as claimed in claim 12, wherein the vehicle or part thereof includes at least one screen attachable at an interface between a coupled vehicle and trailer and/or between coupled trailers.

20. The vehicle or part thereof as claimed in claim 19, said screens are oriented in a substantially vertical plane, and extend along the majority of a vehicle height of said vehicle/trailer interface.

21. The vehicle or part thereof as claimed in claim 19, said screens are attached along a central longitudinal axis of the vehicle.

22. The vehicle or part thereof as claimed in claim 19, wherein lateral sides of the vehicle or part thereof, include one or more aerodynamic ventilation assemblies oriented at an inclination from vertical upon a lateral side of said vehicle, each said assembly including:
a forward deflector rail, positioned substantially proximal with the body surface shaped to perturb or deflect the airflow outwards by a predetermined extent;
an intermediate planar separating strip substantially flush with the body surface; and
a rearward collector rail, positioned on the opposing side of the intermediate separating strip to the forward deflector rail and oriented substantially parallel to the forward deflector rail;
said rearward collector rail being an extrusion having an arcuate cross section with an opening on a forward leading edge leading to an enclosure within said arcuate extrusion.

23. The vehicle or part thereof as claimed in claim 22, wherein the ventilation assemblies extend substantially between topmost and lowermost vertical extremities of the vehicle sides.

24. The vehicle or part thereof as claimed in claim 23, wherein the ventilation assemblies are inclined from the vertical from a lower position towards the vehicle front, upwards to a higher position towards the vehicle rear.

25. The vehicle or part thereof as claimed in claim 22, wherein said enclosure extends substantially along the length of the collector rail forming a slot between the separating strip/body surface and the collector rail.

26. The vehicle or part thereof as claimed in claim 22, wherein said rearward collector rail cross-section curves outwards and forwards from a slot, away to a point of maximum displacement from the body surface before curving forward and inward toward the body surface.

27. The vehicle or part thereof as claimed in claim 26, wherein said predetermined extent substantially corresponds to said point of maximum displacement.

28. The vehicle or part thereof as claimed in claim 22, wherein said planar separating strip includes one of more apertures extending into the body interior.

29. The vehicle or part thereof as claimed in claim 28, wherein said apertures include an angled deflector portion, oriented to deflect airflow into said vehicle.

30. The vehicle or part thereof as claimed in claim 29, wherein said deflectors transversely span the separation between the front and rear rails, and are oriented with a lower distal portion projecting outwards from the sidewall from an upper proximal attachment point.

31. A kit of aerodynamic parts for a vehicle or part thereof, wherein the kit comprises:
a leading edge aerofoil (or components for constructing same) as claimed in claim 1, and one or more of the following parts:
an elongated aerodynamic side rail which extends rearwardly from the distal ends of the aerodynamic aid along a length of the vehicle or part thereof;
a rearward body extension element (or components therefor), attachable to the rear-most portion of the vehicle body; and
at least one screen attachable at an interface between a coupled vehicle and trailer and/or between coupled trailers.

32. (canceled)

33. (canceled)

34. A vehicle or part thereof as claimed in claim 17, wherein the vehicle or part thereof includes at least one screen attachable at an interface between a coupled vehicle and trailer and/or between coupled trailers.
